(19) United States
(12) Patent Application Publication
(10) Pub. No.: US 2026/0184320 A1
(43) Pub. Date: Jul. 2, 2026

(54) VEHICLE CONTROL DEVICE AND METHOD THEREFORE

(71) Applicants: HYUNDAI MOTOR COMPANY, SEOUL (KR); KIA CORPORATION, SEOUL (KR); KOREA UNIVERSITY OF TECHNOLOGY AND EDUCATION INDUSTRY-UNIVERSITY COOPERATION FOUNDATION, CHEONANSI (KR)

(72) Inventors: Jee Yoon Suh, Hwaseong-si (KR); Seung Han You, Seoul (KR); Wan Ki Cho, Suwon-si (KR)

(73) Assignees: HYUNDAI MOTOR COMPANY, SEOUL (KR); KIA CORPORATION, SEOUL (KR); KOREA UNIVERSITY OF TECHNOLOGY AND EDUCATION INDUSTRY-UNIVERSITY COOPERATION FOUNDATION, CHEONANSI (KR)

(21) Appl. No.: 19/229,394

(22) Filed: Jun. 5, 2025

(30) Foreign Application Priority Data
Dec. 26, 2024 (KR) 10-2024-0197141

(51) Int. Cl. B60W 50/00; B60W 10/08; B60W 30/14

(52) U.S. Cl. CPC B60W 50/0098; B60W 10/08; B60W 30/143; B60W 2050/0022; B60W 2520/10; B60W 2520/105; B60W 2520/12; B60W 2520/125; B60W 2520/14; B60W 2710/083; B60W 2720/106

(57) ABSTRACT

A vehicle control device includes a sensor that acquires driving information of a vehicle, a drive motor that controls a longitudinal behavior of the vehicle, and a processor connected to the sensor and the drive motor. The processor determines an initial target longitudinal acceleration based on the driving information, determines a target longitudinal acceleration to reduce a longitudinal jerk determined based on the initial target longitudinal acceleration and a longitudinal acceleration tracking degree determined based on the initial target longitudinal acceleration, and controls the drive motor using a torque calculated based on the target longitudinal acceleration.

### CROSS REFERENCE TO RELATED APPLICATIONS

This application claims the benefit of priority to Korean Patent Application No. 10-2024-0197141, filed in the Korean Intellectual Property Office on Dec. 26, 2024, the entire contents of which are incorporated herein by reference.

### TECHNICAL FIELD

The present disclosure relates to a vehicle control device and a method therefore, and more particularly, to a technology capable of improving ride comfort while considering vehicle stability.

### BACKGROUND

To enhance driver convenience and driving safety, the development of Advanced Driver Assistance Systems (ADAS) has been actively progressing. ADAS may control the acceleration and deceleration of a vehicle independently of a driver's operation to ensure passenger safety.

Vehicle acceleration and deceleration control by ADAS is performed separately from the driver's direct control, causing discomfort in ride quality for the driver or passengers.

As user demand for improved ride comfort in vehicles continues to grow, there is a need for a solution to enhance ride comfort when ADAS is applied.

### SUMMARY

The present disclosure has been made to solve the above-mentioned problems occurring in the prior art while advantages achieved by the prior art are maintained intact.

An aspect of the present disclosure provides a vehicle control device and a method therefore, which enhance ride comfort for passengers while maintaining driving stability in a vehicle based on a driver assistance system.

An aspect of the present disclosure provides a vehicle control device and a method therefore, which improves passenger ride comfort during cruise operation when a vehicle velocity changes due to obstacles.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control device includes a sensor that acquires driving information of a vehicle, a drive motor that controls a longitudinal behavior of the vehicle, and a processor connected to the sensor and the drive motor. The processor may determine an initial target longitudinal acceleration based on the driving information, determine a target longitudinal acceleration to reduce a longitudinal jerk determined based on the initial target longitudinal acceleration and a longitudinal acceleration tracking degree determined based on the initial target longitudinal acceleration, and control the drive motor using a torque calculated based on the target longitudinal acceleration.

In an embodiment, the processor may determine the initial target longitudinal acceleration based on a cruise set velocity.

In an embodiment, the processor may determine the target longitudinal acceleration to reduce magnitude of a first function that determines a longitudinal acceleration of the vehicle based on the target longitudinal acceleration, a lateral velocity of the driving information, and a yaw rate.

In an embodiment, the processor may determine the target longitudinal acceleration to reduce magnitude of a second function that determines a lateral acceleration of the vehicle based on the target longitudinal acceleration, a lateral acceleration of the driving information, and the yaw rate.

In an embodiment, the processor may determine the target longitudinal acceleration to reduce magnitude of a third function that determines the longitudinal jerk based on the rate of change of the target longitudinal acceleration, the lateral acceleration, the yaw rate, the lateral velocity, and the rate of change of the yaw rate in the driving information.

In an embodiment, the processor may determine the target longitudinal acceleration to reduce magnitude of a fourth function that determines the longitudinal acceleration tracking degree based on a difference between the initial target longitudinal acceleration and a target longitudinal velocity.

In an embodiment, the processor may determine the target longitudinal velocity to reduce magnitude of an objective function that is calculated as a sum of the first to fourth functions.

In an embodiment, the processor may differently determine weights to be reflected in the first to fourth functions in the objective function based on time to collision.

In an embodiment, the processor may determine the weights to set the magnitude of the fourth function to be larger as the time to collision decreases.

In an embodiment, the processor may determine the weights to set at least one of the first to third functions to be larger as the time to collision increases.

According to an aspect of the present disclosure, a vehicle control method includes determining, by a processor, an initial target longitudinal acceleration based on driving information of a vehicle, determining, by the processor, a target longitudinal acceleration to reduce a longitudinal jerk determined based on the initial target longitudinal acceleration and a longitudinal acceleration tracking degree determined based on the initial target longitudinal acceleration, and controlling, by the processor, a drive motor using a torque calculated based on the target longitudinal acceleration.

In an embodiment, the determining of the initial target longitudinal acceleration may be performed using a cruise set velocity.

In an embodiment, the determining of the target longitudinal acceleration may include determining the target longitudinal acceleration to reduce magnitude of a first function that determines a longitudinal acceleration of the vehicle based on the target longitudinal acceleration, a lateral velocity of the driving information, and a yaw rate.

In an embodiment, the determining of the target longitudinal acceleration may include determining the target longitudinal acceleration to reduce magnitude of a second function that determines the lateral acceleration of the vehicle based on the target longitudinal acceleration, a lateral acceleration of the driving information, and the yaw rate.

In an embodiment, the determining of the target longitudinal acceleration may include determining the target longitudinal acceleration to reduce magnitude of a third function that determines the longitudinal jerk based on the rate of change of the target longitudinal acceleration, the lateral acceleration, the yaw rate, the lateral velocity, and the rate of change of the yaw rate in the driving information.

In an embodiment, the determining of the target longitudinal acceleration may include determining the target longitudinal acceleration to reduce magnitude of a fourth function that determines the longitudinal acceleration tracking degree based on a difference between the initial target longitudinal acceleration and a target longitudinal velocity.

In an embodiment, the determining of the target longitudinal acceleration may include determining the target longitudinal velocity to reduce magnitude of an objective function that is calculated as a sum of the first to fourth functions.

In an embodiment, the determining of the target longitudinal acceleration may include differently determining weights to be reflected in the first to fourth functions in the objective function based on time to collision.

In an embodiment, the differently determining of the weights may include setting a weight to be reflected in the fourth function to be larger as the time to collision decreases.

In an embodiment, the differently determining of the weights may include setting weights to be reflected in the first to third functions to be larger as the time to collision increases.

### BRIEF DESCRIPTION OF THE FIGURES

The above and other objects, features and advantages of the present disclosure will be more apparent from the following detailed description taken in conjunction with the accompanying drawings:

FIG. 1 is a diagram illustrating a vehicle control device according to an embodiment of the present disclosure;

FIG. 2 is a flowchart for describing a vehicle control method according to an embodiment of the present disclosure;

FIG. 3 is a diagram illustrating a vehicle control device according to another embodiment of the present disclosure;

FIG. 4 is a diagram for describing a vehicle control method according to another embodiment of the present disclosure;

FIG. 5 is a diagram for describing a method for determining weights according to an embodiment of the present disclosure;

FIG. 6 a diagram for describing a method for setting weights according to another embodiment of the present disclosure;

FIGS. 7 and 8 show simulation results of a vehicle control method according to an embodiment of the present disclosure; and

FIG. 9 is a diagram illustrating a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

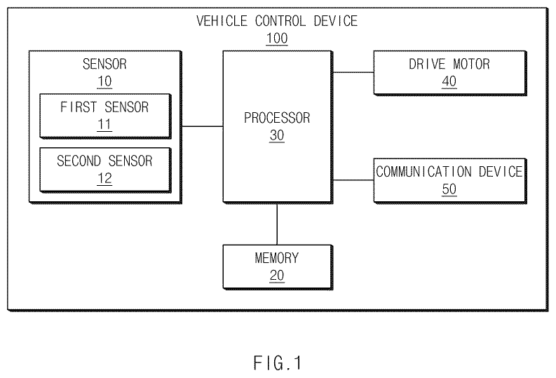

Hereinafter, embodiments of the present disclosure will be described in detail with reference to FIGS. 1 to 9.

FIG. 1 is a diagram illustrating a vehicle control device according to an embodiment of the present disclosure.

Referring to FIG. 1, a vehicle control device 100 according to an embodiment of the present disclosure may be mounted on a vehicle VEH and may include a sensor 10, a memory 20, a processor 30, a drive motor 40, and a communication device 50.

The sensor 10 is for acquiring driving information of the vehicle VEH, and may include a first sensor 11 for acquiring external environment information of the vehicle VEH and a second sensor 12 for acquiring status information of the vehicle VEH.

The first sensor 11 may include a camera, a Light imaging Detection and Ranging (LiDAR), a Radio Detection and Ranging (RADAR), an ultrasonic sensor, an infrared sensor or the like.

The second sensor 12 may include a sensor for acquiring vehicle status information from a driver input. The driver input may include, for example, a steering angle or an acceleration position sensor (APS) signal due to operation by a driver occupying the vehicle VEH.

The second sensor 12 may include a yaw rate sensor, a longitudinal acceleration sensor, a lateral acceleration sensor, a steering angle sensor, a wheel velocity sensor, an acceleration position sensor (APS), a brake position sensor (BPS) and the like.

The sensor 10 may further include other sensors known in the art to acquire driving information of the vehicle VEH or to obtain driving status information of the vehicle VEH.

The memory 20 may store algorithms for the operation of the processor 30 and an AI processor. The memory 20 may be implemented using a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), Dynamic Random Access Memory (DRAM), a Synchronous Dynamic Random Access Memory (SDRAM), a Double Date Rate-SDRAM (DDR-SDRAM), and the like.

The processor 30 may be connected to the sensor 10, the memory 20, the drive motor 40, and the communication device 50 to control the overall operation of the vehicle control device 100. The processor 30 may execute instructions, which may be in the form of a computer-readable recording medium stored in the memory 20, and may perform a certain operation based on the execution of the instructions.

In an embodiment, the processor 30 may determine a target longitudinal acceleration of the vehicle VEH while reducing a longitudinal jerk of the vehicle VEH.

To this end, the processor 30 may determine an initial target longitudinal acceleration based on driving information acquired by the sensor 10 of the vehicle VEH. The processor 30 may determine a target longitudinal velocity to reduce a longitudinal jerk and a longitudinal acceleration tracking degree. The processor 30 may control the drive motor 40 using a torque calculated based on the target longitudinal velocity.

The torque may be a magnitude for determining the rotational velocity of the drive motor 40, and may include directionality. For example, front wheels and rear wheels may rotate independently.

The drive motor 40 may be driven by receiving electrical energy and may include a front wheel motor 51 for rotating the front wheels and a rear wheel motor 52 for rotating the rear wheels. The rotational velocity of the drive motor 40 may be determined by the torque generated by the processor 30. The front wheel motor 51 and the rear wheel motor 52 may be driven independently by receiving different torques.

The communication device 50 may be for communicating with another vehicle, an external server, or a terminal outside the vehicle VEH, and may include a wired or wireless communication protocol.

The communication device 50 may support short-range communication by using at least one of Bluetooth®, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies.

The communication device 50 may also include a V2X communication module. The V2X communication module may include RF circuitry for wireless communication protocols with a server (Vehicle to Infra (V2I)), another vehicle (Vehicle to Vehicle (V2V)), or a pedestrian (Vehicle to Pedestrian (V2P)).

The communication device 50 may transmit and receive radio signals to and from at least one of a base station, an external terminal, and a center on a mobile communication network established complied with technical standards or communication methods for mobile communications.

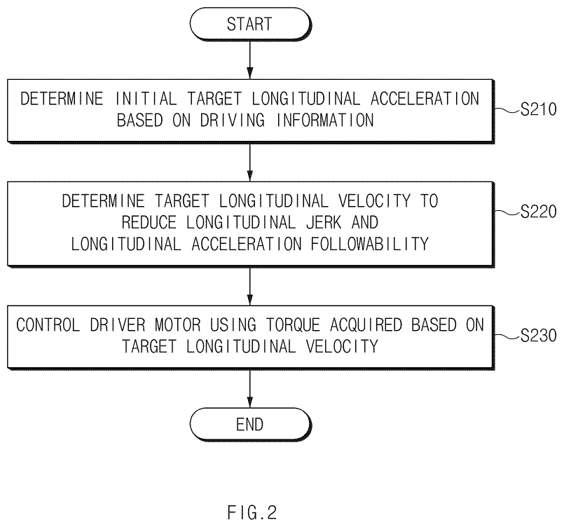

FIG. 2 is a flowchart for describing a vehicle control method according to an embodiment of the present disclosure. FIG. 2 may be a set of processing performed by the processor of FIG. 1.

In S210, the processor 30 may determine an initial target longitudinal acceleration based on driving information.

The initial target longitudinal acceleration may be set by driver input, for example, to drive a vehicle at a certain velocity.

In S220, the processor 30 may determine a target longitudinal velocity to reduce a longitudinal jerk and a longitudinal acceleration tracking degree.

The longitudinal jerk may be determined based on the initial target longitudinal acceleration. For example, the longitudinal jerk may be determined based on the initial target longitudinal acceleration, a lateral acceleration, a yaw rate, and a yaw angle acceleration.

The longitudinal acceleration tracking degree may refer to the degree to which the initial target longitudinal acceleration is followed, and may be determined based on a difference between the initial target longitudinal acceleration and the target longitudinal velocity.

In S230, the processor 30 may determine a torque based on the target longitudinal velocity, and may control the drive motor 40 using the torque.

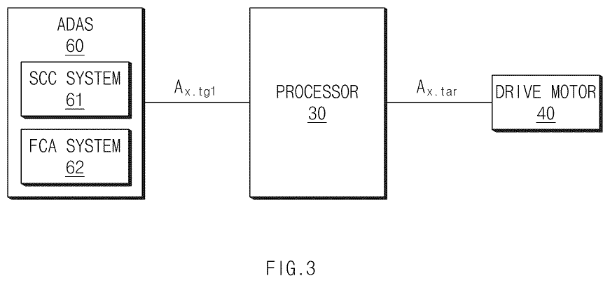

FIG. 3 is a diagram illustrating a vehicle control device according to another embodiment of the present disclosure.

Referring to FIG. 3, a vehicle control device according to another embodiment of the present disclosure may include an advanced driver assistance system (ADAS) 60, the processor 30, and the drive motor 40.

The ADAS 60 is designed to enhance driver safety and convenience and may assist in the driving of the vehicle VEH based on information acquired using the sensor 10, as illustrated in FIG. 1.

The ADAS 60 may include a Smart Cruise Control (SCC) system 61 and a Forward Collision-Avoidance (FCA) system 62.

The SCC system 61 may control a vehicle to maintain a cruise set velocity.

Additionally, the SCC system 61 may control the torque of the drive motor 40 to return the vehicle VEH to the preset velocity when the risk of collision with an obstacle is eliminated after the vehicle (VEH) has decelerated by the FCA system 62 while cruise control is activated.

For example, when the vehicle VEH is traveling at a velocity of 60 km/h due to a setting of the SCC system 61, the velocity of the vehicle VEH may be reduced to 30 km/h due to braking by the FCA system 62 to avoid a collision. When it is determined that the risk of collision has disappeared, the SCC system 61 may control the torque of the drive motor 40 to increase the velocity of the vehicle back to 60 km/h. In this case, the SCC system 61 may determine the initial target longitudinal acceleration (A_{x.tar1}) to control the velocity of the vehicle VEH. The initial target longitudinal acceleration (A_{x.tg1}) may be to determine a torque of the drive motor 40.

The FCA system 62 may detect an obstacle in front of the vehicle VEH and warn of a risk of collision with the detected obstacle. The FCA system 62 may also control the brake of the vehicle VEH based on the risk of collision with the obstacle.

According to an embodiment of the present disclosure, in determining the torque of the drive motor 40 based on the initial target longitudinal acceleration (A_{x.tg1}), the processor 30 may determine the target longitudinal acceleration (A_{x.tar}) by adjusting the initial target longitudinal acceleration (A_{x.tg1}) to ensure that the driver feels comfort. The processor 30 may control the drive motor 40 using the torque determined based on the target longitudinal acceleration (A_{x.tar}).

The processor 30 may determine the target longitudinal acceleration of the vehicle VEH so as to perform Smart Cruise Control (SCC) while reducing longitudinal jerk of the vehicle.

According to an embodiment, the processor 30 may determine the target longitudinal acceleration (A_{x.tar}) to reduce the longitudinal acceleration of the vehicle VEH.

Further, the processor 30 may determine the target longitudinal acceleration (A_{x.tar}) to reduce a lateral acceleration of the vehicle VEH.

Further, the processor 30 may determine the target longitudinal acceleration (A_{x.tar}) to reduce the longitudinal jerk of the vehicle VEH.

Further, the processor 30 may determine the target longitudinal acceleration (A_{x.tar}) to reduce the longitudinal acceleration tracking degree of the vehicle VEH.

In another embodiment, the processor 30 may determine the target longitudinal acceleration (A_{x.tar}) to reduce the magnitude of an objective function.

The objective function “J” may be represented by the following Equation 1

$$J = {{q}_{1} ( {A}_{x . tar} - {V}_{y} γ )}^{2} + {{q}_{2} ( {\dot{V}}_{y} + {V}_{x . tar} γ )}^{2} + {{q}_{3} ( {\dot{A}}_{x . tar} - {\dot{V}}_{y} γ - {V}_{y} \dot{γ} )}^{2} + {{q}_{4} ( {A}_{x . tg 1} - {A}_{x . tar} )}^{2} \qquad Equation 1$$

The objective function “J” expressed in Equation 1 may be described as a sum of first to fourth functions reflecting weights q1 to q4 respectively.

The first function may denote “(A_{x.tar}−V_{y}γ)²”, and the second function may denote “(\dot{V}_{y}+V_{x.tar}γ)²”. The third function may denote “(\dot{A}_{x.tar}−\dot{V}_{y}γ−V_{y}\dot{γ})²”, and the fourth function may denote “(A_{x.tg1}−A_{x.tar})²” The first function may be for determining a longitudinal acceleration reflecting the rotational motion, and the second function may be for determining a lateral acceleration reflecting the rotational motion. Further, the third function may be for determining a longitudinal jerk reflecting the rotational motion. The fourth function may be for determining a longitudinal acceleration tracking degree.

The first function may be for determining a longitudinal acceleration, which may be expressed based on a kinematic role of the vehicle VEH by taking the rotational motion into account. The first function may determine the longitudinal acceleration of the vehicle based on the lateral velocity (V_{y}) and the yaw rate (γ) at the target longitudinal acceleration (A_{x.tar}). The lateral velocity (V_{y}) and the yaw rate (γ) may be information acquired by the sensor 10, or may be estimated based on information acquired by the sensor 10.

The processor 30 may determine a target longitudinal acceleration (A_{x.tar}) to reduce the magnitude of the first function.

The second function may be for determining the lateral acceleration of the vehicle VEH. The second function may determine the lateral acceleration of the vehicle VEH based on the target longitudinal velocity (V_{x.tar}), the lateral acceleration (V_{y}), and yaw rate (γ). The lateral acceleration may be information acquired by the sensor 10 and may also be estimated based on the information acquired by the sensor 10. The target longitudinal velocity (V_{x.tar}) may be determined based on the target longitudinal acceleration (A_{x.tar}) and the target longitudinal velocity (V_{x.k-1}) in the previous timing. For example, the target longitudinal velocity (V_{x.tar}) may be calculated as “V_{x.tar}=TₛA_{x.tar}+V_{x.k-1}” where Tₛ may represent the sampling period.

The processor 30 may determine the target longitudinal acceleration (A_{x.tar}) to reduce the magnitude of the second function.

The third function may be for determining the longitudinal jerk of the vehicle VEH. The third function may determine the longitudinal jerk based on the rate of change of the target longitudinal acceleration (\dot{A}_{x.tar}), the lateral acceleration (\dot{V}_{y}), the yaw rate (γ), the lateral velocity (V_{y}), and the rate of change of the yaw rate (\dot{γ}).

The processor 30 may determine the target longitudinal acceleration (A_{x.tar}) to reduce the magnitude of the third function.

The fourth function may be for determining the longitudinal acceleration tracking degree of the vehicle VEH. The fourth function may determine the longitudinal acceleration tracking degree based on the difference between the initial target longitudinal acceleration (A_{x.tg1}) and the target longitudinal acceleration (A_{x.tar}).

The processor 30 may determine the target longitudinal acceleration (A_{x.tar}) to reduce the magnitude of the fourth function.

According to an embodiment, the processor 30 may determine the target longitudinal acceleration (A_{x.tar}) to reduce the objective function “J”, and according to another embodiment, the processor 30 may determine the target longitudinal acceleration (A_{x.tar}) to minimize the objective function “J”.

The target longitudinal acceleration (A_{x.tar}) may be obtained based on the result of partially differentiating the objective function “J” with respect to time. The partial differentiation of the objective function “J” may be calculated using a discretization method, and the target longitudinal acceleration derived through the discretization method may be expressed in Equation 2.

$${A}_{x . tar . k} = {M}_{1} {V}_{y . k} + {M}_{2} {\dot{V}}_{y . k} - {M}_{3} {A}_{x . k - 1} - {M}_{4} {V}_{x . k - 1} + {M}_{5} {A}_{x . tg 1. k} \qquad Equation 2$$

In Equation 2, “k” may represent the k-th sampling timing. That is, A_{x.tar.k} may represent the k-th target longitudinal acceleration and V_{y.k} represent the k-th lateral velocity. \dot{V}_{y.k} may represent the k-th lateral acceleration, and A_{x.tg1.k} may represent the k-th initial target longitudinal acceleration (A_{x.tg1}).

Furthermore, in Equation 2, the first to fifth variables M₁, M₂, M₃, M₄, and M₅ may be expressed as shown in Equation 3.

$${M}_{1} = \frac{( {q}_{1} {γ}_{k} + {q}_{3} {\dot{γ}}_{k} )}{( {q}_{1} + {q}_{2} {T}_{s}^{2} {γ}_{k}^{2} + \frac{{q}_{3}}{{T}_{s}^{2}} + {q}_{4} )} \qquad Equation 3$$

$${M}_{2} = \frac{( - {q}_{2} {T}_{s} {γ}_{k} + {q}_{3} {γ}_{k} )}{( {q}_{1} + {q}_{2} {T}_{s}^{2} {γ}_{k}^{2} + \frac{{q}_{3}}{{T}_{s}^{2}} + {q}_{4} )}$$

$${M}_{3} = \frac{{q}_{3}}{( {q}_{1} + {q}_{2} {T}_{s}^{2} {γ}_{k}^{2} + \frac{{q}_{3}}{{T}_{s}^{2}} + {q}_{4} )}$$

$${M}_{4} = \frac{{q}_{2} {T}_{s} {γ}_{k}^{2}}{{T}_{s} ( {q}_{1} + {q}_{2} {T}_{s}^{2} {γ}_{k}^{2} + \frac{{q}_{3}}{{T}_{s}^{2}} + {q}_{4} )}$$

$${M}_{5} = \frac{{q}_{4}}{( {q}_{1} + {q}_{2} {T}_{s}^{2} {γ}_{k}^{2} + \frac{{q}_{3}}{{T}_{s}^{2}} + {q}_{4} )}$$

In Equation 3, Ts may represent a sampling period.

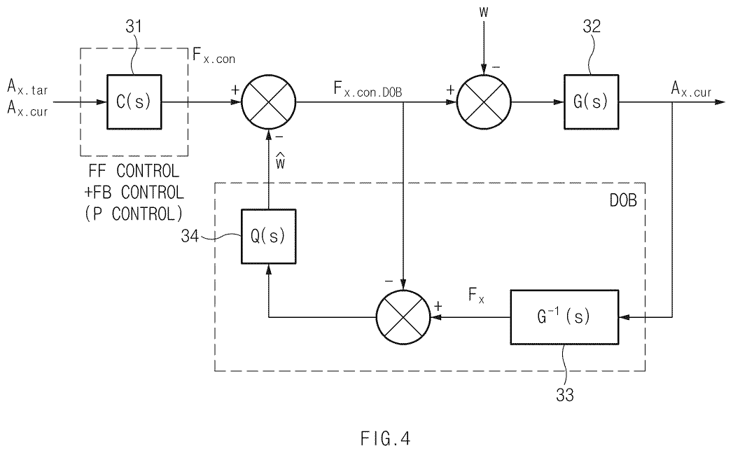

FIG. 4 is a diagram for describing a vehicle control method according to another embodiment of the present disclosure. The operations shown in FIG. 4 may be performed by the processor.

Referring to FIG. 4, the processor 30 may further include a control system 31, an actual system 32, and a disturbance observer DOB. Disturbance (w) may collectively refer to external physical forces applied to the vehicle control device 100 and may include variations in the mass of the vehicle VEH, the gradient of a road surface on which the vehicle VEH is traveling, frictional forces, air resistance, or the like.

The control system 31 may generate a first control output (F_{x.con}) based on feedback control and feedforward control by receiving a target longitudinal acceleration (A_{x.tar}) and a final longitudinal acceleration (A_{x.cur}).

The processor 30 may generate the second control output (F_{x.con.DOB}) by subtracting an estimated disturbance (ŵ) from the first control output (F_{x.con}) and may add the disturbance (w) to the second control output (F_{x.con.DOB}) to provide the second control output, to which the disturbance is added, to the control system 31.

The control system 31 may receive the second control output (F_{x.con.DOB}) to which the disturbance (w) is added, and output the final longitudinal acceleration (A_{x.cur}) to be supplied to the drive motor 40.

An inverse-function system 33 of the disturbance observer DOB may receive the output of the actual system 32 and output the estimated input (Fx) of the actual system 32 as well as the disturbance. The estimated disturbance (ŵ) may be output by subtracting the second control output (F_{x.con.DOB}) from the output of the inverse-function system 33.

A Q-filter 34 of the disturbance observer DOB may be for transforming the inverse-function system 33 into a transfer function system and may be implemented with a low-pass filter.

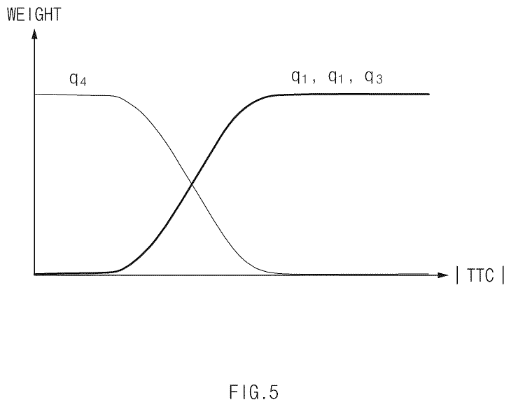

FIG. 5 is a diagram for describing a method for determining weights according to an embodiment of the present disclosure.

Referring to FIG. 5, the processor 30 may determine a first weight q1, a second weight q2, a third weight q3, and a fourth weight q4 based on the time to collision (TTC).

The time to collision may be a value obtained by dividing the relative distance between the vehicle VEH and an obstacle by the relative velocity of the vehicle VEH with respect to the velocity of the obstacle.

The processor 30 may set the magnitude of the fourth weight q4 to be larger as the time to collision decreases. The fourth weight q4 may be reflected in the fourth function. The magnitude of the fourth function may be set proportionally to the magnitude of the fourth weight q4. Thus, to reduce the magnitude of the objective function “J” expressed in [Equation 1], the processor 30 may set the magnitude of the fourth function to be smaller compared to the first to third functions. The magnitude of the fourth function may be derived as a smaller value as the difference between the target longitudinal acceleration (A_{x.tar}) and the initial target longitudinal acceleration (A_{x.tg1}) is smaller. The initial target longitudinal acceleration (A_{x.tg1}) may be output by the ADAS 60. When the time to collision is short, the initial target longitudinal acceleration (A_{x.tg1}) may be derived as a large value by the FCA system 62. In other words, when the time to collision is short, the target longitudinal acceleration (A_{x.tar}) may be set closer to the target longitudinal velocity derived by the FCA system 62.

As the time to collision increases, the operation of the FCA system 62 may be ignored, and accordingly, the fourth weight q4 may be set to a smaller value.

Additionally, the longitudinal acceleration of the vehicle VEH, the lateral acceleration of the vehicle VEH, and longitudinal jerk of the vehicle VEH may be factors related to passenger comfort. That is, as the time to collision increases, the processor 30 may set the first weight q1, the second weight q2, and the third weight q3 to be larger to enhance ride comfort.

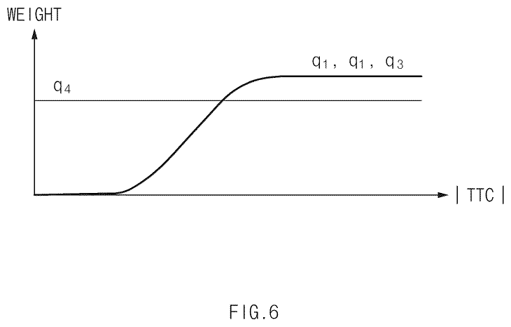

FIG. 6 a diagram for describing a method for setting weights according to another embodiment of the present disclosure.

Referring to FIG. 6, in another embodiment of the present disclosure, the processor 30 may maintain the magnitude of the fourth weight q4 at a constant level. Additionally, as the time to collision increases, the processor 30 may set the first weight q1, the second weight q2, and the third weight q3 to be larger to enhance ride comfort.

In another embodiment, even when the magnitude of the fourth weight q4 is maintained at a constant level, the magnitudes of the first to third weights q1, q2, and q3 may be adjusted based on the time to collision. That is, based on the time to collision, the processor 30 may adjust the first to third weights q1, q2, and q3, which affect ride comfort, to maximize ride comfort within a range that does not compromise the driving safety of the vehicle VEH.

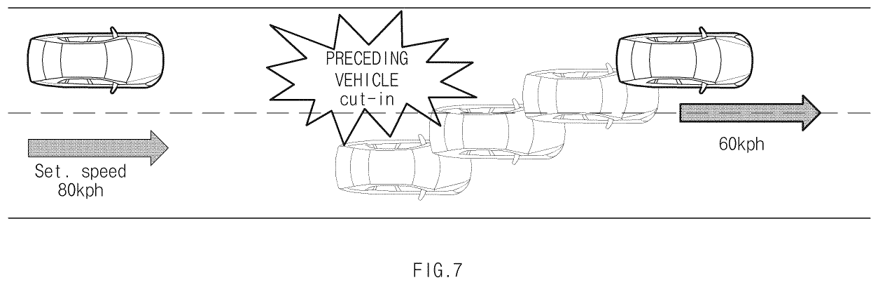

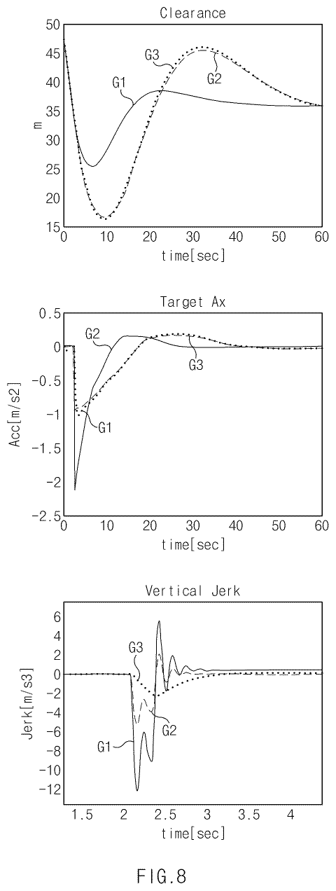

FIGS. 7 and 8 show simulation results of a vehicle control method according to an embodiment of the present disclosure. FIG. 7 illustrates a scenario where a cut-in vehicle appears in front of a host vehicle, and FIG. 8 shows changes in clearance, target longitudinal acceleration (A_{x.tar}), and longitudinal jerk under the situation of FIG. 7. In FIG. 8, first graph G1 may represent a case where the embodiment of the present disclosure is not applied. That is, first graph G1 may illustrate a situation where the drive motor 40 is driven based on the initial target longitudinal acceleration output by the ADAS 60 of FIG. 3. In FIG. 8, second graph G2 may correspond to control that does not consider longitudinal jerk. That is, second graph G2 may represent a situation where the drive motor 40 is driven based on the target longitudinal velocity acquiring by setting the third weight to zero in the objective function “J”. The third graph G3 in FIG. 8 may correspond to an embodiment that considers longitudinal jerk. In other words, the third graph G3 may represent an embodiment in which the drive motor 40 is controlled using the target longitudinal velocity acquired based on the objective function “J” expressed in Equation 1.

Referring to FIGS. 7 and 8, when a cut-in vehicle appears while the SCC system 61 is set at a velocity of 80 km/h, the FCA system 62 may reduce the initial target longitudinal acceleration to perform braking. Accordingly, the clearance, which is proportional to the inter-vehicle distance, may decrease.

Due to the braking of the vehicle VEH by the FCA system 62, the target longitudinal acceleration and longitudinal jerk may change. Then, after the collision risk is eliminated, the ADAS 60 may significantly adjust the initial target longitudinal acceleration to follow the velocity of 80 km/h.

As described above, during the deceleration and acceleration sections of the vehicle VEH, significant changes in the target longitudinal acceleration (A_{x.tar}) and longitudinal jerk may occur. Referring to FIG. 8, it may be known that the variations in target longitudinal acceleration (A_{x.tar}) and longitudinal jerk appear more significant in first graph G1 compared to second graph G2 and third graph G3. This indicates that the control method according to the embodiment of the present disclosure may reduce variations in longitudinal acceleration to enhance ride comfort.

In particular, second graph G2, which represents the results of control performed based on the objective function “J” including the third function, shows a significant improvement in longitudinal jerk.

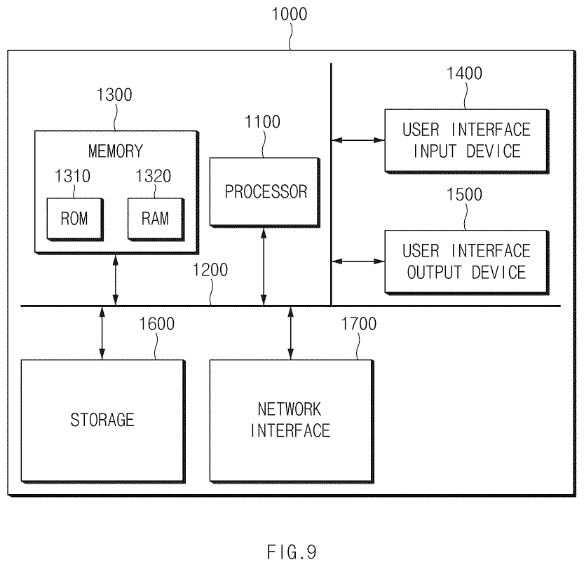

FIG. 9 is a diagram illustrating a computing system according to an embodiment of the present disclosure.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The example storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

According to embodiments of the present disclosure, the longitudinal jerk may be reduced while reducing the longitudinal acceleration tracking degree, thereby improving occupant comfort while maintaining the driving stability of the vehicle.

Furthermore, according to embodiments of the present disclosure, the jerk caused by the change in acceleration of the vehicle during cruise operation may be improved, thereby improving the comfort of the occupants.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A vehicle control device comprising:
a sensor configured to acquire driving information of a vehicle;
a drive motor configured to control a longitudinal behavior of the vehicle; and
a processor connected to the sensor and the drive motor;
wherein the processor is configured to:
determine an initial target longitudinal acceleration based on the driving information;
determine a target longitudinal acceleration to reduce a longitudinal jerk determined based on the initial target longitudinal acceleration;
determine a longitudinal acceleration tracking degree determined based on the initial target longitudinal acceleration; and
control the drive motor using a torque calculated based on the target longitudinal acceleration.

2. The vehicle control device of claim 1, wherein the processor is further configured to determine the initial target longitudinal acceleration based on a cruise set velocity.

3. The vehicle control device of claim 2, wherein the processor is further configured to determine the target longitudinal acceleration to reduce a magnitude of a first function that determines a longitudinal acceleration of the vehicle based on the target longitudinal acceleration, a lateral velocity of the driving information, and a yaw rate.

4. The vehicle control device of claim 3, wherein the processor is further configured to determine the target longitudinal acceleration to reduce a magnitude of a second function that determines a lateral acceleration of the vehicle based on the target longitudinal acceleration, a lateral acceleration of the driving information, and the yaw rate.

5. The vehicle control device of claim 4, wherein the processor is further configured to determine the target longitudinal acceleration to reduce a magnitude of a third function that determines the longitudinal jerk based on the rate of change of the target longitudinal acceleration, the lateral acceleration, the yaw rate, the lateral velocity, and the rate of change of the yaw rate in the driving information.

6. The vehicle control device of claim 5, wherein the processor is further configured to determine the target longitudinal acceleration to reduce a magnitude of a fourth function that determines the longitudinal acceleration tracking degree based on a difference between the initial target longitudinal acceleration and a target longitudinal acceleration.

7. The vehicle control device of claim 6, wherein the processor is further configured to determine a target longitudinal velocity to reduce a magnitude of an objective function that is calculated as a sum of the first, second, third, and fourth functions.

8. The vehicle control device of claim 7, wherein the processor is further configured to determine weights to be reflected in the first, second, third, and fourth functions in the objective function based on a time to collision.

9. The vehicle control device of claim 8, wherein the processor is further configured to determine the weights to set the magnitude of the fourth function to be larger as the time to collision decreases.

10. The vehicle control device of claim 8, wherein the processor is further configured to determine the weights to set at least one of the first, second, or third functions to be larger as the time to collision increases.

11. A vehicle control method comprising:
determining, by a processor, an initial target longitudinal acceleration based on driving information of a vehicle;
determining, by the processor, a target longitudinal acceleration to reduce a longitudinal jerk determined based on the initial target longitudinal acceleration and a longitudinal acceleration tracking degree determined based on the initial target longitudinal acceleration; and
controlling, by the processor, a drive motor using a torque calculated based on the target longitudinal acceleration.

12. The vehicle control method of claim 11, wherein the determining of the initial target longitudinal acceleration is performed using a cruise set velocity.

13. The vehicle control method of claim 12, wherein the determining of the target longitudinal acceleration includes determining the target longitudinal acceleration to reduce a magnitude of a first function that determines a longitudinal acceleration of the vehicle based on the target longitudinal acceleration, a lateral velocity of the driving information, and a yaw rate.

14. The vehicle control method of claim 13, wherein the determining of the target longitudinal acceleration includes determining the target longitudinal acceleration to reduce a magnitude of a second function that determines the lateral acceleration of the vehicle based on the target longitudinal acceleration, a lateral acceleration of the driving information, and the yaw rate.

15. The vehicle control method of claim 14, wherein the determining of the target longitudinal acceleration includes determining the target longitudinal acceleration to reduce a magnitude of a third function that determines the longitudinal jerk based on the rate of change of the target longitudinal acceleration, the lateral acceleration, the yaw rate, the lateral velocity, and the rate of change of the yaw rate in the driving information.

16. The vehicle control method of claim 15, wherein the determining of the target longitudinal acceleration includes determining the target longitudinal acceleration to reduce a magnitude of a fourth function that determines the longitudinal acceleration tracking degree based on a difference between the initial target longitudinal acceleration and a target longitudinal acceleration.

17. The vehicle control method of claim 16, wherein the determining of the target longitudinal acceleration includes determining a target longitudinal velocity to reduce a magnitude of an objective function that is calculated as a sum of the first to fourth functions.

18. The vehicle control method of claim 17, wherein the determining of the target longitudinal acceleration includes determining weights to be reflected in the first, second, third, and fourth functions in the objective function based on a time to collision.

19. The vehicle control method of claim 18, wherein the determining of the weights includes setting a weight to be reflected in the fourth function to be larger as the time to collision decreases.

20. The vehicle control method of claim 18, wherein the determining of the weights includes setting weights to be reflected in the first, second, and third functions to be larger as the time to collision increases.
